(19) United States
(12) Patent Application Publication
(10) Pub. No.: US 2005/0155845 A1
(43) Pub. Date: Jul. 21, 2005

(54) Particulate matter conveyor

(75) Inventor: Donald Barry Webb, Tallai, (AU)

Correspondence Address: HOWREY SIMON ARNOLD & WHITE LLP, c/o IP DOCKETING DEPARTMENT, 2941 FAIRVIEW PARK DRIVE, SUITE 200, FALLS CHURCH, VA, 22042-7195, US

(73) Assignee: FIBRECYCLE PTY LTD, QUEENSLAND (AU)

(21) Appl. No.: 10/510,491

(22) PCT Filed: Apr. 8, 2003
(86) PCT No.: PCT/AU03/00421

(30) Foreign Application Priority Data
Apr. 8, 2002 (AU) PS 1607

(51) Int. Cl. B65G 33/06

(52) U.S. Cl. 198/663; 198/669

(57) ABSTRACT

A particulate matter conveyor (10) is disclosed including: a supply bin or hopper (14) for supplying paper particles to a supply end (12) of a transition duct (11), the particles being conveyed through a main passage (17) in the duct and expelled through a discharge outlet (21) at a dispense end (13) of the duct; at least two contra-rotating screws (22) driven by a screw driving means (25) and mounted in the transition duct, the screws being cantilevered at one end to the supply end and are unsupported at the dispense end of the duct; whilst a substantially constant clearance between blades (23) on the screws and the main passage allows for an even and uninterrupted flow of particles through the transition duct.

### TECHNICAL FIELD

The present invention relates to an apparatus for conveying particulate matter, and more typically for conveying shredded particulate paper.

### BACKGROUND ART

Particulate matter of a dry fibrous nature is difficult for process machinery to handle. Particular difficulties are encountered with mechanically conveying dry paper fibre in paper recycling and other paper processes which can lead to erratic output and increased maintenance on process machines. Paper fibres, even when dry have a tendency to collect at corners and edges, and conglomerate together which can lead to jamming and overloading of the conveying machinery.

Using the paper recycling industry as an example, serious problems have been encountered with conveying fibre particles from a storage bin containing pre-broken paper through a converging area in preparation for grinding the paper in a hammer mill. Ideally, fibre particles should exit the conveyor in a loose form under a constant and even flow. However, owing to the nature of paper particles to collect at corners and other sharp angles in the conveyor, blockages and jams frequently occur which can cause machine seizure. The interruption to flow through the conveyor produces spasmodically dispensed paper that is difficult to meter and therefore makes it difficult to quantify the volumetric output of conveyed paper. The compacted and bulky condition of conveyed paper is additionally undesirable for introducing into the next machine in the process as it can cause shock-loading in the machine.

It is therefore desired with the present invention to provide a conveyor for paper particles, which will not jam or seize but rather operate efficiently to convey and dispense paper at a constant and even rate.

### DISCLOSURE OF THE INVENTION

According to the present invention there is provided a particulate matter conveyor including:
a supply means for supplying paper particles to a supply end of a transition duct, the particles being conveyed through a main passage in the duct and expelled through a discharge outlet at a dispense end of the duct;
at least two contra-rotating screws driven by a screw driving means and mounted in the transition duct, the screws being cantilevered at one end to the supply end and are unsupported at the dispense end of the duct;
wherein a substantially constant clearance between blades on the screws and the main passage allows for an even and uninterrupted flow of particles through the transition duct.

It is preferable that there is also a constant clearance between the blades themselves, namely by positioning the blades of the screws 180° out of phase to one another.

Preferably, the particulate paper conveyor has a minimum constant clearance of 50 mm and, to prevent slippage or stalling of particle flow, there is a maximum constant clearance of 100 mm. A preferred constant clearance is approximately 75 mm.

The supply hopper ideally feeds particles through an inlet opening in the transition duct located above the screws and adjacent the main passage. To improve flow characteristics through the conveyor, the screws preferably contain a stepped shaft wherein the step in the shaft is directly below the inlet opening, the smaller diameter maintained through the main passage to the discharge outlet. The shaft step is preferably located at a point vertically below the periphery of the inlet that is further from the supply end of the transition duct, and more specifically vertically below the periphery and slightly back from a direct line below the periphery and inside of the inlet opening. Preferably, the step is approximately 50 mm back from the direct line.

To improve the flow in the main passage there is preferably provided a restriction vertically below the periphery of the inlet that restricts the clearance between the supply end and the main passage to a maximum of 35 mm from the blades.

An airflow at the dispense end of the transition duct is preferably provided to create a vacuum effect to assist the particle flow through the conveyor and to create a negative pressure gradient between the inlet and outlet thereby preventing the rise of dust in the hopper.

### BRIEF DESCRIPTION OF THE DRAWINGS

The present invention is described further by way of example with reference to the accompanying drawings by which:

FIG. 1 is a side sectional view of a particulate paper conveyor in accordance with a first preferred embodiment of the present invention;

FIG. 2 is a plan view of the conveyor taken at section 2-2 of FIG. 1;

FIG. 3 is an end view of the conveyor taken at section 3-3 of FIG. 1; and

FIG. 4 is a side sectional view, the same as that of FIG. 1, but in accordance with a second preferred embodiment of the invention.

### BEST MODES FOR CARRYING OUT THE INVENTION

In the first preferred embodiment of the present invention, a particulate matter conveyor is used in recycling paper products to produce paper particulate whereby waste paper is shredded, ground then conditioned according to its end use. For example, paper particulate may be formed into pellets for sale and used as “cat litter” or may be combined with a fuel mixture and manufactured into briquettes as a readily combustible fuel package.

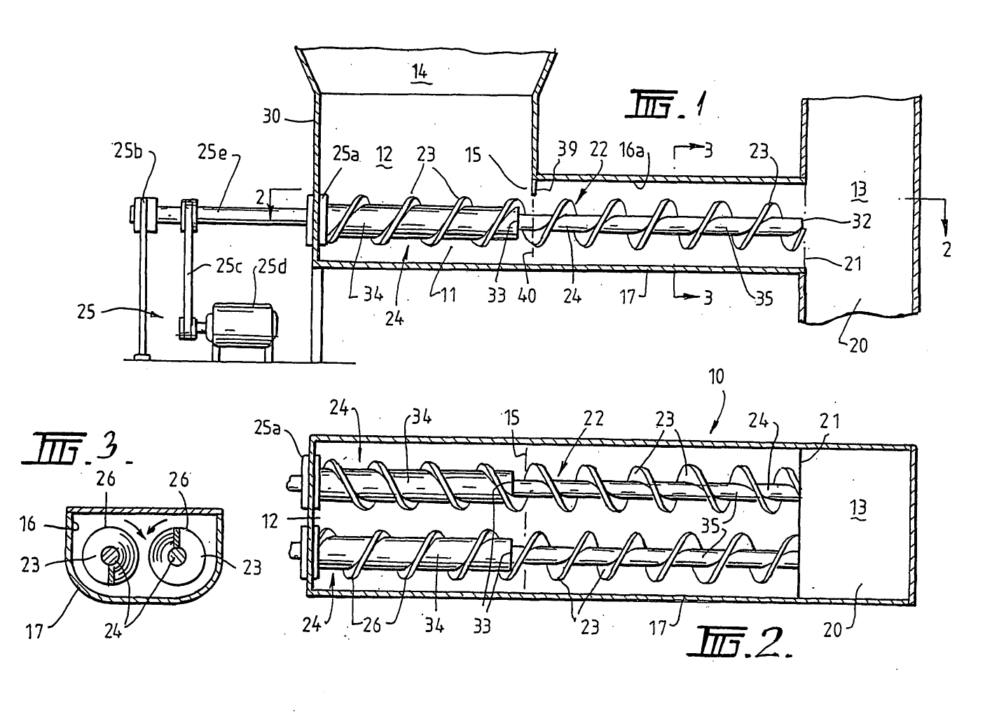

The particulate paper conveyor 10 as illustrated in FIGS. 1 to 3 transfers preliminarily sized paper in the recycling process from a hopper to a hammer mill for grinding. Conveyor 10 comprises a transition duct 11 having a supply end 12 and a dispense end 13. A storage bin or hopper 14 is located above the transition duct 11 at the supply end 12 to deliver paper fibre into the transition duct through a duct inlet 15. A chute 20 at the dispense end 13 directs paper fibre exiting the transition duct 11 under gravity through duct outlet 21 towards the next process machine, which in the example given is the hammer mill (not shown).

Contra-rotating twin worm screws 22 are used to convey the paper fibre particles from hopper 14 to chute 20. Helical blades 23 on worm screw shafts 24 move the paper fibre along a main passage 17 of the transition duct towards the chute 20. A driving arrangement 25 located outside the transition duct 11 drives the contra-rotating worm screws mounted longitudinally central of the transition duct 11. Since the conveyor relies entirely on the rotating motion of screws 22 to convey the paper fibres, and without the use of a conveyor belt or similar, the screws must be positioned in the duct for optimal, even and uninterrupted flow and to avoid occurrences of jamming owing to uneven and obstructed flow. The clearances between the screws and interior wall 16 of the main passage 17 play an important part in the flow of particulate through the conveyor. Specifically, if there is insufficient clearance anywhere in the main passage 17 between the blades on the screws and main passage, “nip” points are likely to develop. Nip points are areas susceptible to build up of paper, for example corners or points of construction, where the probability of flow jams are high. At best, flow jams create an undesirable compression of particulate material, and, at worst, machine seizure. In contrast, excessive clearances between the screws and main passage are also undesirable leading to flow slippage and stalling of particulate flow.

As seen in the figures, the clearances between the blades and duct casing in the present conveyor are substantially constant along the length of the main passage and around the periphery of the screws. Providing a clearance that is the same at all points around the screws and along the length of the main passage enables a constant and even flow of paper particulate through the transition-duct. Maintaining a substantially even clearance eliminates nip points and allows for an even particulate flow rate that can be easily metered. Clearance values for a good and even particle flow is independent of the particle feed rate, particulate volume and size of the duct. A clearance of between 50-150 mm, and ideally 120 mm, between the screw blades 23 and the inside wall 16a of the main passage will provide a good consistent flow regardless of conveyor dimensions and flow parameters. A clearance of between 50-100 mm, and in particular between 75-100 mm, will also be satisfactory.

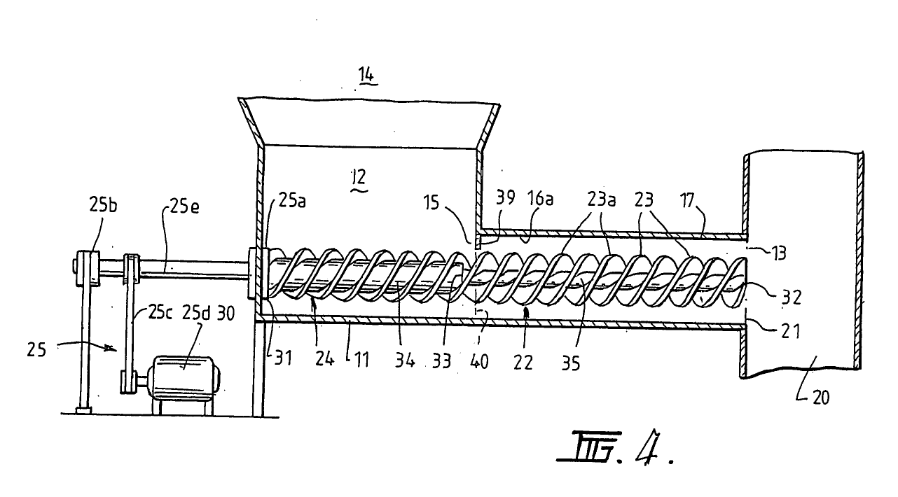

The distance between each screw and the distance between the blades on each screw are also maintained at a constant clearance by placing the blades on the screws 180° out of phase to one another such that there is always a minimum constant clearance between them. As illustrated in FIG. 3, the clearance between blade tips 26 on respective screws is the same as the clearance between blade tips and casing 16, namely 50-100 mm in the above given example. Additionally, the blade depth should be suitable to consistently convey particulate matter, and ideally not less than 50 mm. Blade depth of less than 50 mm will result in slippage or stalling of the flow.

In order to reduce points of obstruction around the worm screws at the dispense end 13, the worm screws are mounted through a bearing arrangement 25a in an end wall 30 of transition duct 11 and subsequently outside to an outrigger bearing arrangement 25b, with a pulley drive 25c between a motor 25d and a drive shaft 25e extending between the shafts of the worm screws, via the bearing arrangements 25a, and the outrigger bearing arrangements 25b. In other words, the worm screws are cantilevered at a first end in end wall 30 on bearing mounts with the second end 32 unsupported at the dispense end 13 such that the screws rotate freely in the duct without obstruction to dispensing paper particulate flow.

In the interest of maintaining a maximum even flow through the duct the shaft diameter 35 of the screws in the main passage 17 is smaller than the shaft diameter at the supply end 12 of the screws. A shaft step 33 delineates the larger diameter 34 from the smaller diameter 35. In order to avoid the obstruction of paper flow from the hopper into the main passage the small shaft diameter is entirely located in the main passage 17 where the conditions for an even flow are most sensitive, whereas the larger diameter is located at the supply end directly underneath the hopper and inlet opening where there is no restriction on space for particulate flow. To avoid impediment of paper fibre as it flows from the hopper and into the transition duct, the shaft step 33 is spaced back towards the supply end from a line 40 vertically below the peripheral end of the duct entrance 15 furthest from the supply end 12. Setting step 33 back a distance of 50-75 mm from this peripheral edge of the duct inlet 15 avoids paper jamming and collecting underneath the hopper before it even enters the main passage.

Regulating the particulate flow even further is a vertical plate 39 positioned vertically at the entrance to the main passage 17 and effectively aligned on line 40. The vertical plate restricts the flow into the main passage such that the clearance between the tip of the blades and vertical plate 39 is no more than approximately 35 mm. Since step 33 in the shaft is stepped 50-75 mm back from line 40, and thus also from vertical plate 39, particulate matter entering the transition duct from the supply hopper is slightly compressed around the region of the stepped bore and the vertical plate. This has the effect of slowing down the flow in this region and regulating it for entering into the less restricted main passage where the particulate flow can expand and flow evenly towards the exit without nipping or stalling the machine.

With the above worm screw arrangement particulate is allowed to flow in an uninterrupted and even manner from the supply hopper to the dispense end 13 and into the chute 20 where it is allowed to fall under its own weight into a collection bin, next machine, or the like. An airflow down through chute 20 may be provided to create a slight vacuum at the discharge end urging particulate paper to dispense from the transition duct into the chute. Additionally, the vacuum effect creates a slight negative pressure gradient between the duct inlet 15 and duct outlet 21 which has the effect of preventing the rise of dust in hopper 14.

Whilst there is a minimum requirement of two worm screws to convey the particulate paper through the conveyor, more than two worm screws may be provided, particularly where the conveyor is required to throughput a larger capacity of particulate.

Although the conveyor is designed to transfer shredded particulate paper, in some instances entire newspaper sized sheets may slip through the paper breaking machine without much reduction. The present conveyor is therefore designed to accommodate particulate paper from the size of newspapers down to shredded and ground paper.

Operating the conveyor using counter rotation of worm screws centrally placed within a transition duct so as to have an equal clearance around the screws provides a balanced and efficient means for conveying particulate, and specifically pre-shredded paper from one point to another. The continuous progression of fixed volumes of particulate along the duct ensures the conveyed particulate is loose and free from compressive forces which can lead to jamming and uneven, wave-like dispensing causing internal vibrations, and potentially machine overload and seizure. In terms of preparing the particulate for the subsequent step in the illustrated process, namely grinding, the present conveyor prevents shock loading of the hammer mill grinder and supplies a desirable loose and even flow of conveyed particulate paper at a smaller cross-sectional flow area.

The cantilevered worm screws provide free and unobstructed particulate dispensation which is not achievable if the second end 32 is mounted in an end cover or on a base support.

Metering of particulate flow by passing it by a flow sensor in the present conveyor is accurate and meaningful because the flow is even and constant. A more accurate quantitative assessment of volumetric flow in the process is therefore achievable with the present conveyor.

Referring to FIG. 4 of the drawings, in a second preferred embodiment of the invention, which is a side sectional view the same as that of FIG. 1, and where applicable the same reference numerals have been used, a second helical blade 23a is provided interposed between the helical blade 23, and what is known in the art as a “two start” blade configuration whereby the worm screws 22 particulate is discharged every 180° of rotation of the worm screws 22 instead of every 360° of rotation as with the first preferred embodiment, and such as to produce more even flow of the material, and this second preferred embodiment of the invention is probably the most preferred.

1. A particulate matter conveyor including:
a transition duct having a supply end, a main passage a dispense end, and a discharge outlet at the dispense end;
a supply means for supplying paper particles to a supply end of the transition duct, the particles being conveyed through a the main passage in the duct and expelled through the discharge outlet;
at least two contra-rotating helical conveying screws driven by a screw driving means and mounted in the transition duct, the screws each having at least one helical blade and being cantilevered at one end to the supply end and unsupported at the dispense end of the duct;
wherein a substantially constant clearance between the helical blades and the main passage allows for an even and uninterrupted flow of the particulate through the transition duct.

2. A particulate matter conveyor as claimed in claim 1, wherein there is also a constant clearance between the blades themselves, namely by positioning the blades of the screws 180° out of phase to one another.

3. A particulate matter conveyor as claimed in claim 1, wherein the clearance between the inside of the transition duct and the blades of the screws is between 50-100 mm.

4. A particulate matter conveyor as claimed in claim 1, wherein the supply means feeds particulate through an inlet opening in the transition duct located above the screws and adjacent the main passage.

5. A particulate matter conveyor as claimed claim 4, wherein the screws each have a stepped shaft wherein the step in the shaft is directly below the inlet opening, the smaller diameter maintained through the main passage to the discharge outlet.

6. A particulate matter conveyor as claimed in claim 5, wherein the shaft step is located at a point vertically below the periphery of the inlet that is adjacent the supply end of the transition duct.

7. A particulate matter conveyor as claimed in claim 6, wherein the shaft step is vertically below the periphery and slightly back from a direct line below the periphery and the inside of the inlet opening.

8. A particulate matter conveyor as claimed in claim 6, wherein the shaft step is approximately 50 mm back from a direct line below the periphery and the inside of the inlet opening.

9. A particulate matter conveyor as claimed in claim 1, wherein a restriction is provided vertically below the periphery of the supply means that restricts the clearance between the supply end and the main passage.

10. A particulate matter conveyor as claimed in claim 1, wherein an airflow at the dispense end of the transition duct is provided to create a vacuum effect to assist the particle flow through the conveyor and to create a negative pressure gradient between the inlet and outlets thereby minimising the generation of dust in the hopper.

11. A particulate matter conveyor as claimed in claim 1, wherein two helical blades are provided on each of the helical screws.

12. (canceled)
